(19) United States
(12) Patent Application Publication
(10) Pub. No.: US 2014/0115524 A1
(43) Pub. Date: Apr. 24, 2014

(54) UNIVERSAL X, Y-AXIS POSITIONING INPUT METHOD

(71) Applicant: Yu-Chih Cheng, Taipei (TW)

(72) Inventor: Yu-Chih Cheng, Taipei (TW)

(21) Appl. No.: 14/146,018

(22) Filed: Jan. 2, 2014

Related U.S. Application Data
(63) Continuation of application No. 11/168,492, filed on Jun. 29, 2005, now abandoned.

(30) Foreign Application Priority Data
Feb. 5, 2005 (CN) 200510007935.3

(51) Int. Cl. G06F 3/0488; G06F 3/0482

(52) U.S. Cl. CPC G06F 3/04886; G06F 3/0482
USPC 715/773

(57) ABSTRACT

An input method for an electronic device having a plurality of keys and a display screen is disclosed, wherein a menu having a plurality of character options arranged in an x, y-axis matrix with vertical columns and horizontal rows is displayed on the screen, wherein x-coordinate values of the character options are listed on the display screen to identify character options in each of the horizontal rows and an initial y-coordinate value is set in advance for selecting character options, wherein a desired character option can be selected by using keys for selecting horizontal character option rows and the x-coordinate value of the desired character option can be selected by using keys for selecting x-coordinate values, so as to input the desired character option, wherein all selectable character options are displayed on the display screen prior to the selection of the y-coordinate of the horizontal character option row.

### CROSS-REFERENCE TO RELATED APPLICATION

This application is a continuation of U.S. application Ser. No. 11/168,492, filed on Jun. 29, 2005, which claims the priority benefit of China application No. 200510007935.3, filed on Feb. 5, 2005. The entirety of the above-mentioned patent application is hereby incorporated by reference herein and made a part of specification.

### BACKGROUND OF THE INVENTION

1. Field of the Invention

The present invention generally relates to an input method and an input apparatus applicable for texts, alphabets, symbols and/or function keys of any languages, and more particularly to those applied in electronic devices such as a mobile phone or a remote controller having number keys, direction keys, and a display screen.

2. Description of the Related Art

At present, the input of characters or texts into a common mobile phone or remote controller divides the character or text into a plurality of groups corresponding to a plurality of press keys on the mobile phone. Since the number of characters is much larger than the number of press keys, therefore each press key corresponds to a plurality of characters, and each key disposed on a very limited space of a keyboard is engraved with several small characters. Such arrangement not only gives a very small size of characters and a difficulty of recognizing the small characters, but also makes it difficult for users to find their desired character, particularly for those who have bad eyesight. Furthermore, one press key corresponds to several characters, and it thus requires additional procedure such as adding more steps or memories to improve the accuracy of the input. Some manufacturers make use of a virtual keyboard, which is displayed on a screen, so that users can press specific keys to select their desired character, or use direction keys to move the cursor to select the desired character. Such virtual keyboard needs to memorize the relation between the characters and their corresponding keys, or memorize the correspondence of a key with its corresponding character. Since the press key has a specified correspondence, therefore the flexibility and range of its use are restricted, and it is unable to increase the speed or add more functions. Further, it is necessary to press the direction keys for several times to select the desired characters, and such complicated operating procedure slows down the speed.

### SUMMARY OF THE INVENTION

To overcome the difficulty of locating the marked character and the shortcoming of the slow and complicated operating procedure when inputting a character or text to the mobile phone or remote controller, the present invention provides an input method applicable for texts, alphabets, symbols and/or function keys for any languages, and this method can avoid the operating procedure from locating the marked characters on the keyboard, save the memory, and reduce the number of pressing the keys, so as to achieve a simple, convenient and fast input effect.

To achieve the foregoing objectives, the present invention provides a universal x, y coordinates positioning input method that integrates characters and/or function keys into a plurality of character options to define a menu of columns in at least two rows to be displayed on a screen, wherein the menu at its upper section marks x-coordinate for each character option by an horizontal number row, and the horizontal number row is controlled by number keys to select the x-coordinate, and an initial y-coordinate value corresponding to the horizontal character option row is set for the y-coordinate of the character option row and displayed by a method other than those for displaying other character option rows, and direction keys are used to select and control the y-coordinates, and one character option row is selected at a time, and the desired character option is shown on the menu for selecting the coordinates so as to complete inputting a character.

The universal x, y coordinates positioning input method is characterized in that it can display elements such as texts, alphabets and/or symbols etc. for any languages.

The universal x, y coordinates positioning input method is characterized in that the function keys are keys for controlling the operating functions.

The universal x, y coordinates positioning input method is characterized in that the character option is a single character or a single function key or a combination of several characters.

The universal x, y coordinates positioning input method is characterized in that the menu is divided into several pages if the menu is too large to be displayed at a time, and the direction keys or function keys are used to select each page, and one page is displayed at a time.

The universal x, y coordinates positioning input method is characterized in that the number keys are press keys having at least ten keys from 0 to 9.

The universal x, y coordinates positioning input method is characterized in that the direction keys include the direction moving devices such as direction keys, joysticks, and/or rollers dials etc.

The universal x, y coordinates positioning input method is characterized in that the way of setting the values of x, y-axis is interchangeable.

The present invention also provides an electronic product that adopts the foregoing universal x, y-axis input method.

More specifically, the technical solution adopted by the present invention to solve the technical issues includes: integrating the inputted characters and/or function keys into a plurality of character options to define a menu having columns in at least two rows to be displayed on a screen. The character option could be a single character or a single function key or a combination of several characters to be allocated for a local display menu on the screen. If the whole menu cannot be displayed at a time, then the menu is divided into several pages, and each page of the menu is displayed at a time. The present invention indicates that there also includes a number of other pages for the selection by using the pages selected indicating symbol and cooperates with the direction keys or function keys to complete the page selecting procedure. The character option displayed in the menu is arranged in the x, y-axis matrix. The horizontally arranged row is called a row, and the vertically arranged column is called a column, and a value of x-coordinate of the character option is listed on the upper section of the menu and controlled and selected the value of x-coordinate by the number keys, and there are at least two values for the y-axis of the character option rows. An initial y-axis value is set in advance, and the corresponding horizontal character option row is displayed by a method other than those for displaying other character option rows, such as using a reverse attribute or other different colors to represent the selected y-coordinate corresponding to the character option row. The direction keys are used to select the y-coordinates. A certain character option is going to be selected from a page of a menu, then first the corresponding direction keys are used to move the initial value of the y-coordinate to the y-coordinate of the character option row including the desired character option to complete a quick positioning of the y-coordinate so as to select a row. The number keys corresponding to the value of the x-coordinate of the desired character option are pressed to complete the quick positioning of the value of the x-coordinate, so as to input the contents of the desired character option. If the desired character option is not shown in the menu on the screen, the corresponding direction keys or the function keys are pressed and selected according to the pages selected indicating symbols to show the next page of the menu, until the page of the menu containing the desired character option appears. Similarly, the display or operation can be carried out according to the shape of the character option to interchange the way of setting the coordinates. In other words, the values of the y-coordinate are represented by numbers, and the value of the x-coordinate is displayed by the method other than that of other character option columns.

Therefore, as to the benefits of the present invention about the texts, alphabets, symbols and/or function keys for any language, the desired character option is shown on the screen, and thus the invention can overcome the difficulties of locating the small characters crowded on a keyboard. With the simple method of using the direction keys, a row or a column of character options can be selected at a time. With the number keys for selecting the value of another coordinate, the desired character option can be positioned quickly, and thus reducing the number of keystrokes. Users can sense the keys from the coordinates of the screen, the marking of function keys and selected page without memorizing the correspondence between the characters and the press keys or memorizing the characters represented by each press key. The invention provides users a simple operation. Since more than one character of the desired character option adopted for the invention can be inputted at a time, and thus simplifying the operating procedure and achieve the simple, convenient and quick input effect.

### BRIEF DESCRIPTION OF THE DRAWINGS

Other features and advantages of the present invention will become apparent in the following detailed description of the preferred embodiments with reference to the accompanying drawings, in which:

FIG. 1 is a schematic view of a menu displaying the English letters in upper case on a screen according to the present invention;

FIG. 2 is a schematic view of number keys and direction keys according to the present invention;

FIG. 3 is a schematic view of pressing the number key “1” to select CL (Caps Lock) function key for displaying a menu in lower case English letters as depicted in FIG. 1 and then pressing the “Down” direction key to move the values of y-coordinate to the next row according to the present invention;

FIG. 4 is a schematic view of a screen displaying the first page of a menu for selecting the Chinese phonetics according to the present invention;

FIG. 5 is a schematic view of a screen displaying the second page of a menu for selecting the Chinese phonetics according to the present invention;

FIG. 6 is a schematic view of a Chinese phonetics menu displaying the interchangeable way of selecting the values of the coordinates after the sound “f” is selected as depicted in FIG. 4;

FIG. 7 is a schematic view of a menu for selecting the Chinese character roots by the Changjei input method displayed on screen;

FIG. 8 is a schematic view of a menu for the value of y-coordinate selected by the “Up” direction key as depicted in FIG. 7.

The numerals used in the figures are described as follows:

1 stands for the character option; 2 for the horizontal number row for the values of x-coordinate of the character options; 3 for the initial y coordinate value corresponding to a horizontal character option row; 4 for the Caps Lock function key; 5 for the Shift function key; 6 for Space key; 7 for the number keys; 8 for the direction keys; 9 for the page selected indicating symbol for selecting the next page; 10 is a character option having two characters; 11 for the page selected indicating symbol for selecting the previous page; 12 for the initial x-coordinate value corresponding to a vertical character option column; and 13 for the values of the y-coordinate of the vertical numerical column indicates the horizontal character option rows.

### DETAILED DESCRIPTION OF THE PREFERRED EMBODIMENTS

The present invention can be used for any languages and programming languages, and the following embodiments adopt the English language and Chinese language for the description, but the scope of the present invention is not limited to these languages only. Any modifications or similar arrangements and procedures are included in the scope of the appended claims and should be accorded the broadest interpretation so as to encompass all such modifications and similar arrangements and procedures.

Referring to FIG. 1 for the first preferred embodiment of the present invention, the upper case English alphabets are displayed on a screen in accordance with the technology of the present invention. The x-coordinates mark a row of numbers 1, 2, . . . 0 (2) and the y-coordinate points at the highlighted middle row (3). If it is necessary to enter “Abc”, the operating procedure will be as follows:

1. In FIG. 1, the number key “2” is pressed to select and enter “A”.

2. In FIG. 1, the number key “1” is pressed to select the “CL” Caps Lock function key (4) to display the lower case alphabets on the screen.

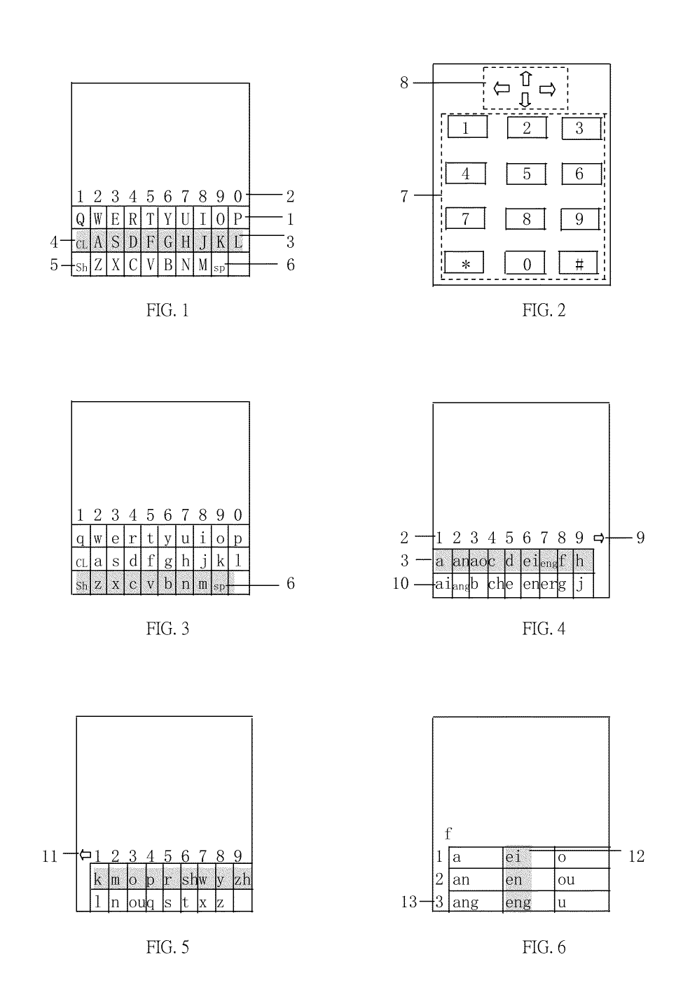

3. The “Down” direction key is pressed to select the y-coordinate of the next row as shown in FIG. 3.

4. The number key “6” is pressed as shown in FIG. 3 to select and input “b”. The y-coordinate will automatically return to the initial value which is the middle row.

5. The “Down” direction key is pressed to move the y-coordinate to the next row as shown in FIG. 3.

6. The number key “4” is pressed as shown in FIG. 3 to select and input “c”, so as to complete the input of “Abc”, and the y-coordinate automatically returns to the initial value which is the middle row.

Therefore, it is not necessary to locate the small characters on the keyboard to input English or to memorize the corresponding relation between the characters and keys. Users just need to operate the general number keys and direction keys for a total of 6 times to complete entering the alphabets both in upper and lower cases.

Referring to FIG. 4 for the second embodiment of the present invention, the Chinese phonetics are integrated in the menu to be displayed on the screen, and the numbers of the horizontal number row including 1, 2, . . . 9 at the utmost top of the x-coordinate are marked (2), and the initial value of the y-coordinate is pointed at the highlighted row (3), wherein the character options include a single character, two characters (10) and three characters. Since the menu has two pages, and the page selected indicating symbol (9) indicates to select the next page as shown in FIG. 4 or the page selected indicating symbol indicates to select the previous page as shown in FIG. 5. If it is necessary to enter “feng”, then the operating procedure will be as follows:

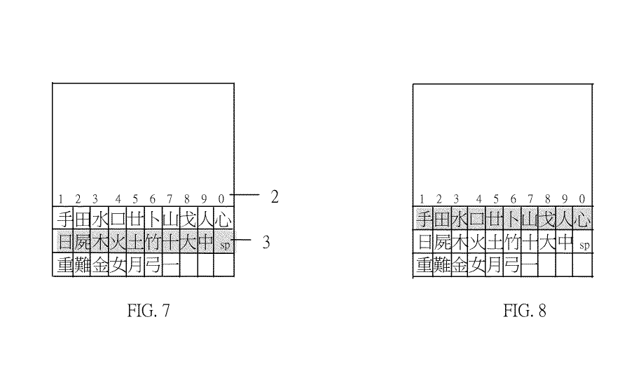

1. The number key “8” is pressed as shown in FIG. 4 to select and input “f”. The screen will show the phonetic “f” and any possible character options thereafter as shown in FIG. 6. The numbers of the y-coordinate 1, 2, 3 at the utmost left row of the y-coordinate are marked (13), and the initial value of the x-coordinate is pointed at the middle highlighted column (12).

2. In FIG. 6, the number key “3” is pressed to select and input “eng” to complete entering the Chinese phonetics “feng”, and users can find all of the Chinese characters with the same phonetics.

Therefore, users just need to press the number keys for two times to enter “feng”, and also can find out all of the Chinese characters with the same phonetics for selection. Such arrangement is simple, convenient and quick, and does not require users to locate the small characters on the keyboard, or memorize the corresponding relation between the phonetics and the characters, or press the direction keys for many times for the positioning.

Referring to FIG. 7 for the third preferred embodiment of the present invention, the Chinese character roots of Changjei input method are integrated into the menu to be displayed on a screen, and the numbers 1, 2 . . . 9, 0 of the horizontal number row at the utmost top row of the x-coordinate are marked (2), and the initial value of the y-coordinate is pointed at the middle highlighted row (3). If it is necessary to input “ [symbol] ” to form Chinese character “ [symbol] ”, the operating procedure will be as follows:

1. In FIG. 7, the number key “3” is pressed to select and input “ [symbol] ”.

2. In FIG. 7, the “Up” direction key is pressed to move the y-coordinate to one row above as shown in FIG. 8.

3. In FIG. 8, the number key “2” is pressed to select and input “ [symbol] ”. The value of the y-coordinate automatically returns to the middle row as shown in FIG. 7.

4. In FIG. 7, the number key “0” is pressed to select and enter “space” to complete entering the Chinese character “ [symbol] ”.

Therefore, users only need to press the keys for four times to enter the Chinese words “ [symbol] ” by the Changjei input method. Such arrangement is simple, convenient and quick, and users need not to find the small characters on the keyboard, or remember the corresponding relation between the Chinese character roots and the characters, or press the direction keys for many times for the positioning.

What is claimed is:

1. An input method for an electronic device having a plurality of keys and a display screen, the method comprising the steps of:
(a) displaying on the display screen a menu having a plurality of character options for inputting data, wherein the plurality of character options are present in an x, y-axis matrix with vertical columns and at least two horizontal rows, and wherein x-coordinate values of the character options are listed on the display screen to identify character options in each of the at least two horizontal rows, respectively, and wherein an initial y-coordinate value is set in advance and the corresponding horizontal character option row is displayed differently from the other horizontal character option rows; and
(b) selecting a horizontal character option row that includes a desired character option by using a first set of keys for selecting horizontal character option rows; and selecting the x-coordinate value of the desired character option by using a second set of keys for selecting x-coordinate values, so as to input the desired character option, wherein all selectable character options are displayed on the display screen prior to the selection of the horizontal character option row.

2. The input method of claim 1, wherein each character option is a single character, a single function key or a combination of a plurality of characters.

3. The input method of claim 1, wherein the first set of keys are direction keys and the second set of keys are numeric keys.

4. The input method of claim 1, wherein the input method is inputting a word according to an input method rule, the method further comprising the steps of:
(c) fetching the contents of the desired character option and determining whether the word is formed according to the contents of the desired character option and said input method rule; and
(d) inputting the word if the word is formed; otherwise, repeating step (a), step (b), step (c) and step (d) until the word is inputted.

5. The input method of claim 2, wherein in step (a) said single function key is one of the following keys: a shift key to capitalize a character, a space key to end a sequence of inputting character options in order to form the word.

6. The input method of claim 2, wherein said menu is divided into a plurality of pages, wherein said function keys are used to select each page and display one page at a time.

7. The input method of claim 3, wherein said menu is divided into a plurality of pages, wherein said direction keys are used to select each page and display one page at a time.

8. The input method of claim 1, wherein in step (a) the x-coordinate values of the character options are listed in a horizontal number row on the upper section of the menu.

9. The input method of claim 4, wherein the input method rule is Chinese Changjei input method rule, wherein each character option represents a symbol in the Chinese Changjei input method rule, wherein multiple symbols are used to form the word in Chinese.

10. The input method of claim 2, wherein at least one of the plurality of character options is a combination of a plurality of characters.

11. An input method for an electronic device having a plurality of keys and a display screen, the method comprising the steps of:
(a) displaying on the display screen a menu having a plurality of character options for inputting data, wherein the plurality of character options are present in an x, y-axis matrix with at least two vertical columns and horizontal rows, and wherein y-coordinate values of the character options are listed on the display screen to identify each character option in each of the at least two vertical columns, respectively, and wherein an initial x-coordinate value is set in advance and the corresponding vertical column is displayed differently from the other vertical columns; and
(b) selecting a vertical character option column that includes a desired character option by using a first set of keys for selecting vertical character option columns; and selecting the y-coordinate value of the desired character option by using a second set of keys for selecting y-coordinate values, so as to input the desired character option, wherein all selectable character options are displayed on the display screen prior to the selection of the vertical character option column.

12. The input method of claim 11, wherein each character option is a single character, a single function key or a combination of a plurality of characters.

13. The input method of claim 11, wherein the first set of keys are direction keys and the second set of keys are numeric keys.

14. The input method of claim 11, wherein the input method is inputting a word according to an input method rule, the method further comprising the steps of:
(c) fetching the contents of the desired character option and determining whether the word is formed according to the contents of the desired character option and said input method rule; and
(d) inputting the word if the word is formed; otherwise, repeating step (a), step (b), step (c) and step (d) until the word is inputted.

15. The input method of claim 12, wherein in step (a) said single function key is one of the following keys: a shift key to capitalize a character, a space key to end a sequence of inputting character options in order to form the word.

16. The input method of claim 12, wherein said menu is divided into a plurality of pages, wherein said function keys are used to select each page and display one page at a time.

17. The input method of claim 13, wherein said menu is divided into a plurality of pages, wherein said direction keys are used to select each page and display one page at a time.

18. The input method of claim 11, wherein in step (a) the y-coordinate values of the character options are listed in a vertical number column on the left most section of the menu.

19. The input method of claim 14, wherein the input method rule is Chinese Changjei input method rule, wherein each character option represents a symbol in the Chinese Changjei input method rule, wherein multiple symbols are used to form the word in Chinese.

20. The input method of claim 12, wherein at least one of the plurality of character options is a combination of a plurality of characters.
